(19) United States
(12) Patent Application Publication
(10) Pub. No.: US 2009/0006250 A1
(43) Pub. Date: Jan. 1, 2009

(54) METHODS AND SYSTEMS FOR TRACKING AND REPORTING FINANCIAL TRANSACTIONS

(75) Inventors: Matt Bixler, Denver, CO (US); Robert Newton, San Francisco, CA (US); Dean Seifert, Parker, CO (US); Dave Owen, Castle Rock, CO (US); Elizabeth Petri, Littleton, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: The Western Union Company, Englewood, CO (US)

(21) Appl. No.: 12/123,856

(22) Filed: May 20, 2008

Related U.S. Application Data
(60) Provisional application No. 60/946,344, filed on Jun. 26, 2007.

(51) Int. Cl. G06Q 90/00

(52) U.S. Cl. 705/39

(57) ABSTRACT

This disclosure describes, generally, methods and systems for tracking and reporting multiple financial transactions. The method may include initiating a financial transaction by a user at an interface. The financial transaction may include multiple transactional steps. The method may further include generating notifications corresponding to the plurality of transactional steps. A first notification may be configured to indicate to the user that payment for the transaction has been initiated. A second notification may be configured to indicate to the user that the transaction has been processed and released for payment, and a third notification may be configured to indicate to the user that the transaction's funds have been made available.

### PRIORITY CLAIM

This application claims priority to U.S. Provisional Application No. 60/946,344, entitled METHODS AND SYSTEMS FOR TRACKING AND REPORTING FINANCIAL TRANSACTIONS, filed on Jun. 26, 2007.

### FIELD OF THE INVENTION

This invention relates generally to financial transaction reporting. More specifically the invention relates to tracking and reporting a financial transaction's status as the transaction is processed.

### BACKGROUND OF THE INVENTION

Currently, small and medium businesses (e.g. less than 100 employees) engaging in international trade are often unsure of when a sent payment (e.g. via wire, cash or other electronic method) will arrive at its intended destination. There are often delays between five and ten businesses days for bank wires. Consequently, the parties (e.g. sender and receiver) may not have any knowledge of where a given payment is within the process.

Furthermore, if there is a problem with the payment (e.g. wrong routing number), the parties involved in the transaction may not be made aware of the problem until after the end of the five to ten day period. Such uncertainty of the payment progress creates concern and inefficiency for both the buyer and/or the seller. In most cases, sellers are not willing to release goods or authorize services until they receive payment confirmation and thus the uncertainty of payment timing results in the delayed shipment of goods or authorization of services, which creates a less efficient transaction process. Current manual methods of tracking payments (e.g. calling banks, phone conversations, faxes, emails, etc.) are cumbersome and time consuming. Accordingly, a more efficient and automatic tracking and reporting system of such transactions is needed.

### BRIEF SUMMARY OF THE INVENTION

Embodiments of the present invention are directed to a method of tracking and reporting multiple financial transactions. The method may include initiating a financial transaction by a user at an interface. The financial transaction may include multiple transactional steps. The method may further include generating notifications corresponding to the plurality of transactional steps. A first notification may be configured to indicate to the user that payment for the transaction has been initiated. A second notification may be configured to indicate to the user that the transaction has been processed and released for payment, and a third notification may be configured to indicate to the user that the transaction's funds have been made available.

According to further embodiments, a system for tracking and reporting multiple financial transactions, is described. In one embodiment the system may include a payment center. The payment center may be configured to receive a financial transaction initiation request. The financial transaction may include multiple transactional steps. Furthermore, the payment center may be further configured to generate notifications regarding the plurality of transactional steps.

In an alternative embodiment, a machine-readable medium is described. The machine-readable medium may include instructions initiating a financial transaction by a user at an interface. The financial transaction may include multiple transactional steps. The machine-readable medium may further include instructions for generating notifications corresponding to the plurality of transactional steps. A first notification may be configured to indicate to the user that payment for the transaction has been initiated. A second notification may be configured to indicate to the user that the transaction has been processed and released for payment, and a third notification may be configured to indicate to the user that the transaction's funds have been made available.

### BRIEF DESCRIPTION OF THE DRAWINGS

The present invention is described in conjunction with the appended figures.

FIG. 1 is a flow diagram illustrating a method for tracking and reporting financial transactions according to embodiments of the present invention.

FIG. 2 is a block diagram illustrating a system for tracking and reporting financial transactions according to embodiments of the present invention.

FIG. 3 is a generalized schematic diagram illustrating a computer system, in accordance with various embodiments of the invention.

FIG. 4 is a block diagram illustrating a networked system of computers, which can be used in accordance with various embodiments of the invention.

In the appended figures, similar components and/or features may have the same numerical reference label. Further, various components of the same type may be distinguished by following the reference label by a letter that distinguishes among the similar components and/or features. If only the first numerical reference label is used in the specification, the description is applicable to any one of the similar components and/or features having the same first numerical reference label irrespective of the letter suffix.

### DETAILED DESCRIPTION OF THE INVENTION

The ensuing description provides exemplary embodiments only, and is not intended to limit the scope, applicability or configuration of the disclosure. Rather, the ensuing description of the exemplary embodiments will provide those skilled in the art with an enabling description for implementing one or more exemplary embodiments. It being understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination corresponds to a return of the function, to the calling function, or the main function.

The term “machine-readable medium” includes, but is not limited to portable or fixed storage devices, optical storage devices, wireless channels and various other mediums capable of storing, containing or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine-readable medium. In addition, a processor(s) may perform the necessary tasks.

One aspect of the invention enables a user (e.g. a buyer, a seller, a shipper, a customer, a freight seller, a supplier, etc.) of online and/or offline payment services to track financial transactions and receive status notifications at key stages (e.g. payment initiation, payment processed, funds available, exception notification, delivery, etc.) within the transaction process. Furthermore, the payment systems and methods may be used as described in U.S. Pat. No. 7,117,178, filed on Sep. 26, 2001, entitled SYSTEMS AND METHODS TO FACILITATE PAYMENT FOR SHIPPED GOODS, U.S. Pat. No. 6,994,251, filed on May 22, 2003, entitled CASH PAYMENT FOR REMOTE TRANSACTIONS, and U.S. Patent Publication No. 20070016489, filed Jul. 17, 2006, entitled SYSTEMS AND METHODS FOR ENROLLING CONSUMERS IN GOODS AND SERVICES all incorporated by reference in their entirety for any purpose.

A further aspect of the invention is to provide a user centralized reporting. For example, if during a given time period a user has multiple transactions with multiple entities, it may be difficult for the user to keep track of all of these transactions. The present invention provides a centralized reporting system that groups all such transactions together for easy viewing and tracking. The user may also be given the option of sorting the reports (e.g. sorting by entity, date, category, monetary value, etc.).

In a further aspect of the invention, the user may interact with a web site to view and/or generate reports. The web site may display the status of various pending transactions, as well as provide detailed reporting of an individual transaction. For example, a user may select an individual transaction and be able to view status points (described in more detail below) for that transaction.

The transaction may be between a buyer and a seller for the purchase of goods or services. The buyer may need to transfer funds to the seller in order to receive the purchased goods or services. The buyer may initiate a funds transfer and be able to track the funds transfer status at each point in the transaction. The buyer may further use the above mentioned web site to access the status information. Accordingly, if there is a problem at any point with the transaction, the buyer can then inform the seller of such a problem.

Furthermore, the user may have the ability to track financial transactions via an interactive voice recognition (IVR) system, voice response unit (VRU) system, and/or a mobile device (e.g. a cellular telephone, a personal digital assistant (PDA), etc.).

An example of one embodiment of the invention may be a goods dealer (e.g., a rug dealer) in Chicago, Ill. (i.e. the buyer) is interested in purchasing inventory from a supplier in New Zealand (i.e. the seller). In one embodiment, both the buyer and the seller are subscribers to Western Union® Global Business Payments; however, other services may be used (such as the payment system described in CONSOLIDATED PAYMENT OPTIONS, Attorney Docket No. 026595-010300US, filed concurrently herewith, and incorporated by reference in its entirety and for any purpose). After the buyer and the seller agree to the terms of the transaction, the seller may provide the buyer with an invoice of the transaction. In one embodiment, the seller fills out the invoice by providing the appropriate information (e.g., price, quantity, date of delivery, parties involved, etc.) to an online service which then generates an invoice.

In one embodiment, the online invoice service may have various menus, forms, options, etc. for generating the invoice and transmitting it to the buyer. The invoice may be equivalent to a standard invoice used in the trade of the buyer and/or the seller. In one embodiment, the invoice is transmitted to the buyer via an email message, a text message, an IVR system, a paper invoice, etc. Upon receipt of the message indicating that the invoice is ready, the buyer may log on to the online service to review the invoice. Upon review the buyer may now execute payment to the seller. For example, per the agreed terms of the invoice, the buyer may execute payment instructions to pay 13,060 New Zealand Dollars (NZD) to be paid to the New Zealand based seller via a bank wire. However, other payment types may be used.

In one embodiment, according to the buyer's instructions the service may transfer the appropriate funds from, for example, the buyer's bank account, convert the currency from United States dollars (USD) to New Zealand Dollars (NZD) and transmit the funds via, for example, a wire transfer to the seller's New Zealand account. At each of these steps the buyer and/or seller may receive a notification indicating the status of each step. For example, a freight forwarder may have access to the system to be notified of when the shipment has been received at port, or when documentation has been received by a buyer. Further, a shipper may have access to the system to be automatically notified when the shipped goods are, for example, on the truck, on the ship, delivered, etc.

Furthermore, when payment is received, both the buyer and the seller may be notified via a selected notification method. The buyer and/or seller may access detailed information about the transaction from a website. The website may be connected to a central server which contains information about the transactions of each of the users of the online service.

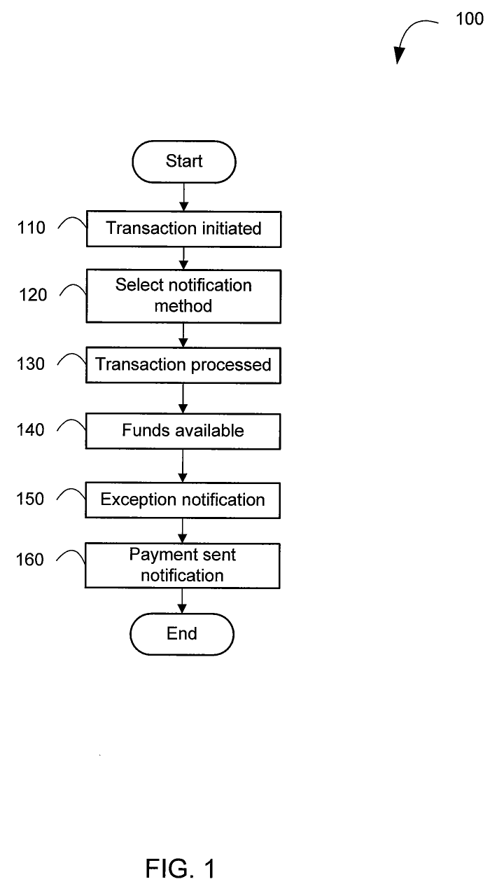

Turning now to FIG. 1, which illustrates a method 100 depicting various points of a notification process for a financial transaction. At process block 110, a financial transaction is initiated (e.g. a payment from a buyer to a seller). The payment may be initiated when the buyer allocates funds for the payment from their funding account (e.g., credit card, debit card, automatic teller card (ATM), prepaid or stored value card, account money order, check, gift certificate, money order, traveler's check) or via a cash payment. In a further embodiment, the buyer and seller are located in different countries.

At process block 120, the user may select the notification method. In one embodiment, the notification method may be via email, interactive voice recognition (IVR), short message system (SMS), telephone, the Internet, a branch location, postal service courier, etc. In addition, the user may access a graphical user interface (GUI) to generate a report summarizing transaction history and/or notifications. Users may also have access to where a payment is via their online or offline Western Union® Global Business Payments account. Users may also be able to track the history of specific payments. Additionally, visual depictions of the key points of the payment process and where specific payments are within the process may be displayed.

In an alternative embodiment, the user may pre-select the notification method. For example, the user may want certain transactions to have one type of notification method, while certain other transactions may have other notification methods. Consequently, the notification method may be completely customizable by the user.

At process block 130, the payment may be processed. Upon processing of the payment, the user may receive a notification indicating that the payment has been processed. This may occur when the amount to be sent has been processed into a payment system (SWIFT for international wires, FED for domestic wires, Western Union for cash, Western Union Payment network, Automated Clearing House (ACH), electronic funds transfer (EFT) network, etc.) that will deliver the funds.

At process block 140, a funds available notification is generated. This notification may inform both the buyer and/or the seller that the sent funds have arrived at the intended account destination. In an alternative embodiment, the notification may indicate that the funds are available for pick up via a Western Union™ agent location. In addition to the funds available notification, a shipment sent and/or shipment received notification may be generated. Such a notification may include, for example, a track number for the shipment, confirmation of arrival of the shipped good, arrival estimations, etc.

At process block 150, any exception notifications are generated. In one embodiment, users may be notified if a payment has not been initiated, processed and/or made available. Further, problems such as bad funds, failed payment attempts, long delays and cash payments not being picked up may be communicated to the buyer and/or seller. This may allow the buyers and/or sellers to remain informed on the transaction status. The buyers and/or sellers are no longer uninformed of the transaction status at key points within the transaction. Exception notifications may be delivered to buyers and/or sellers in order to minimize speculation and confusion.

At process block 160, a payment sent notification may be sent to the buyer and/or seller. The payment sent notification may indicate to the buyer and/or seller that the transaction is complete and that the funds are available for retrieval by the seller. In a further embodiment, the buyer may restrict whether the seller receives certain notifications. For example, the buyer may not want the seller to receive a notification indicating that the buyer has insufficient funds. Accordingly, authorization from the buyer may need to be obtained in order for certain information to be released to the seller.

The reporting process may further provide users with security options. Security may be incorporated into the payment process. For example, web components may be enabled with secure socket layer (SSL) 128 bit encryption. An additional feature of the invention may be that profiles may be created for repeat transactions. For example, buyers and sellers may be able to profile multiple overseas customers and suppliers in an online and/or offline account. This may enable users to easily access payment information for repeat transactions.

Users may also be able to upload invoices or have invoices attached to the various notifications. Furthermore, the user may have the option of a fixed foreign exchange rate, which allows the user to lock in foreign exchange rates for future payments. Further, a user may be able to stage the timing of a payment. For example, the buyer may stage the payment on Monday; however, authorization to release the funds from the buyer's bank account is on Friday.

In a further embodiment, the payment may be divided into components. For example, half of the payment may be delivered “up front” and the other half of the payment may be delivered upon delivery or receipt of the goods and/or services. In addition, the user may be able to establish reoccurring payments and/or transactions. After an initial setup of a payment, the user may be able to indicate that this is payment is to reoccur, for example, on a weekly, monthly, yearly, etc., basis, or in response to a certain event (e.g., product inventory level, a price threshold, etc.).

As discussed above, the user may access transaction information via a web site GUI. The web site may allow users to generate administrator and limited user privilege login accounts. For example, administrator privileges may allow full functionality, including account set up and payment. In contrast, limited user privileges may only allow viewing privileges, while not allowing transaction generation. The GUI may have multi-language support and may be interactive.

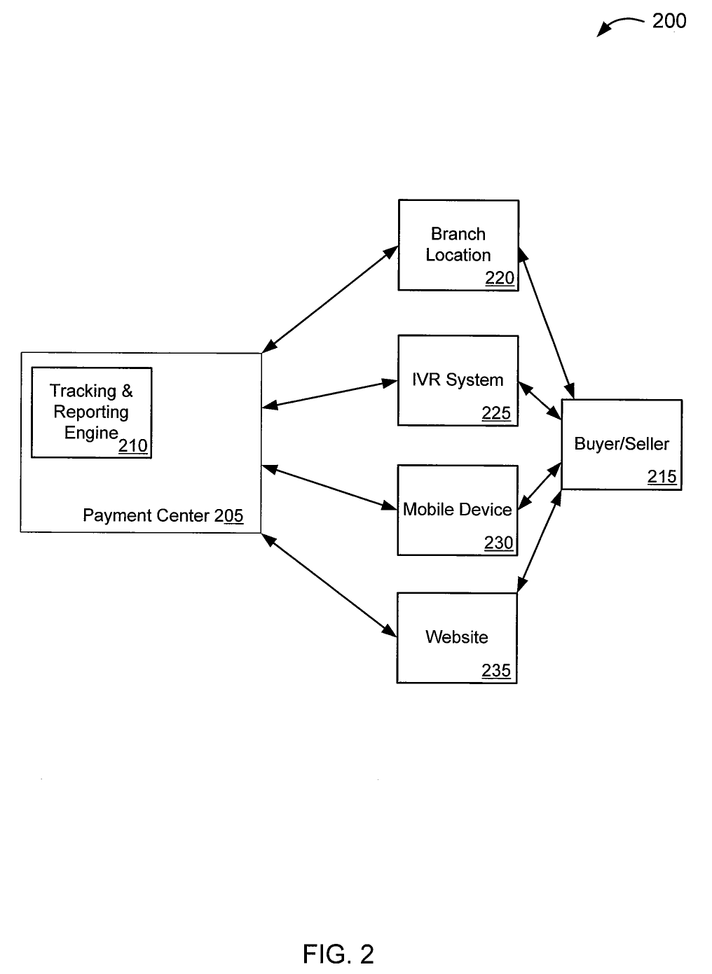

Turning now to FIG. 2 which illustrates a system 200 for tracking and reporting financial transactions according to embodiments of the present invention. In one embodiment, system 200 may include a payment center 205. Payment center 205 may be configured to manage financial transactions initiated between a buyer and a seller. For example, buyer/seller 215 may access payment center 205 via a branch office 220, an interactive voice recognition (IVR) system 225, a mobile device 230, or a website 235. If, for example, the buyer/seller 215 accesses payment center 205 via website 235, buyer/seller 215 may be prompted to logon using a usemame and password. Once buyer/seller 215 has logged on, buyer/seller 215 is then able to initiate a financial transaction, view pending transaction, access notifications for pending transactions, make payments on transactions, etc. Furthermore, buyer/seller 215 may be able to change their user settings. For example, buyer/seller 215 may be able to change the method in which notifications about financial transactions are received, how often notifications are received, what type of notifications are received, etc.

In a further embodiment, payment center 205 may include a tracking and reporting engine 210. Tracking and reporting engine 210 may be configured to track the various transactional steps associated with the various financial transactions. For example, once a payment is processed, tracking and reporting engine 210 may generate a notification indicating that the payment has been processed and transmit the notification to buyer/seller 215 using the selected notification method. In addition, tracking and reporting engine 210 may generate a funds available notification. Such a notification may inform buyer/seller 215 that the sent funds have arrived at the intended account destination.

Tracking and reporting engine 210 may further generate any exception notifications. In one embodiment, buyer/seller 215 may be notified if a payment has not been initiated, processed and/or made available. Further, problems such as bad funds, failed payment attempts, long delays and cash payments not being picked up may be communicated to buyer/seller 215. Additionally, tracking and reporting engine 210 may generate a payment sent notification. In one embodiment, the payment sent notification may indicate to buyer/seller 215 that the transaction is complete and that the funds are available for retrieval by the seller.

In a further embodiment, tracking and reporting engine 210 may generate reports regarding the various financial transactions. Such reports may include a centralized reporting of all financial transactions for buyer/seller 215. For example, if during a given time period buyer/seller 215 has multiple transactions with multiple entities, it may be difficult for the user to keep track of all of these transactions. The generated reports may provide a centralized reporting system that groups all such transactions together for easy viewing and tracking.

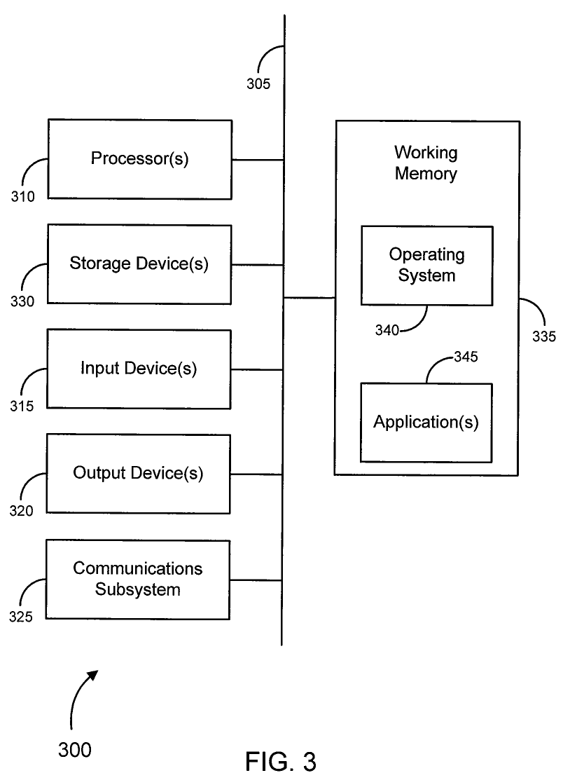

FIG. 3 provides a schematic illustration of one embodiment of a computer system 300 that can perform the methods of the invention, as described herein. It should be noted that FIG. 3 is meant only to provide a generalized illustration of various components, any or all of which may be utilized as appropriate. FIG. 3, therefore, broadly illustrates how individual system elements may be implemented in a relatively separated or relatively more integrated manner.

The computer system 300 is shown comprising hardware elements that can be electrically coupled via a bus 305 (or may otherwise be in communication, as appropriate). The hardware elements can include one or more processors 310, including without limitation one or more general-purpose processors and/or one or more special-purpose processors (such as digital signal processing chips, graphics acceleration chips, and/or the like); one or more input devices 315, which can include without limitation a mouse, a keyboard and/or the like; and one or more output devices 320, which can include without limitation a display device, a printer and/or the like.

The computer system 300 may further include (and/or be in communication with) one or more storage devices 325, which can comprise, without limitation, local and/or network accessible storage and/or can include, without limitation, a disk drive, a drive array, an optical storage device, solid-state storage device such as a random access memory (“RAM”) and/or a read-only memory (“ROM”), which can be programmable, flash-updateable and/or the like. The computer system 300 might also include a communications subsystem 330, which can include without limitation a modem, a network card (wireless or wired), an infrared communication device, a wireless communication device and/or chipset (such as a Bluetooth™ device, an 802.11 device, a WiFi device, a WiMax device, cellular communication facilities, etc.), and/or the like. The communications subsystem 330 may permit data to be exchanged with a network (such as the network described below, to name one example), and/or any other devices described herein. In many embodiments, the computer system 300 will further comprise a working memory 335, which can include a RAM or ROM device, as described above.

The computer system 300 also can comprise software elements, shown as being currently located within the working memory 335, including an operating system 340 and/or other code, such as one or more application programs 345, which may comprise computer programs of the invention, and/or may be designed to implement methods of the invention and/or configure systems of the invention, as described herein. Merely by way of example, one or more procedures described with respect to the method(s) discussed above might be implemented as code and/or instructions executable by a computer (and/or a processor within a computer). A set of these instructions and/or code might be stored on a computer readable storage medium, such as the storage device(s) 325 described above. In some cases, the storage medium might be incorporated within a computer system, such as the system 300. In other embodiments, the storage medium might be separate from a computer system (i.e., a removable medium, such as a compact disc, etc.), and or provided in an installation package, such that the storage medium can be used to program a general purpose computer with the instructions/code stored thereon. These instructions might take the form of executable code, which is executable by the computer system 300 and/or might take the form of source and/or installable code, which, upon compilation and/or installation on the computer system 300 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

In one aspect, the invention employs a computer system (such as the computer system 300) to perform methods of the invention. According to a set of embodiments, some or all of the procedures of such methods are performed by the computer system 300 in response to processor 310 executing one or more sequences of one or more instructions (which might be incorporated into the operating system 340 and/or other code, such as an application program 325) contained in the working memory 335. Such instructions may be read into the working memory 335 from another machine-readable medium, such as one or more of the storage device(s) 325. Merely by way of example, execution of the sequences of instructions contained in the working memory 335 might cause the processor(s) 310 to perform one or more procedures of the methods described herein.

The terms “machine readable medium” and “computer readable medium,” as used herein, refer to any medium that participates in providing data that causes a machine to operate in a specific fashion. In an embodiment implemented using the computer system 300, various machine-readable media might be involved in providing instructions/code to processor(s) 310 for execution and/or might be used to store and/or carry such instructions/code. In many implementations, a computer readable medium is a physical and/or tangible storage medium. Such a medium may take many forms, including but not limited to, non-volatile media, volatile media, and transmission media. Non-volatile media includes, for example, optical or magnetic disks, such as the storage device(s) 325. Volatile media includes, without limitation dynamic memory, such as the working memory 335. Transmission media includes coaxial cables, copper wire and fiber optics, including the wires that comprise the bus 305, as well as the various components of the communication subsystem 330 (and/or the media by which the communications subsystem 330 provides communication with other devices). Hence, transmission media can also take the form of waves (including without limitation radio, acoustic and/or light waves, such as those generated during radio-wave and infrared data communications).

Common forms of physical and/or tangible computer readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of machine-readable media may be involved in carrying one or more sequences of one or more instructions to the processor(s) 310 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 300. These signals, which might be in the form of electromagnetic signals, acoustic signals, optical signals and/or the like, are all examples of carrier waves on which instructions can be encoded, in accordance with various embodiments of the invention.

The communications subsystem 330 (and/or components thereof) generally will receive the signals, and the bus 305 then might carry the signals (and/or the data, instructions, etc., carried by the signals) to the working memory 335, from which the processor(s) 305 retrieves and executes the instructions. The instructions received by the working memory 335 may optionally be stored on a storage device 325 either before or after execution by the processor(s) 310.

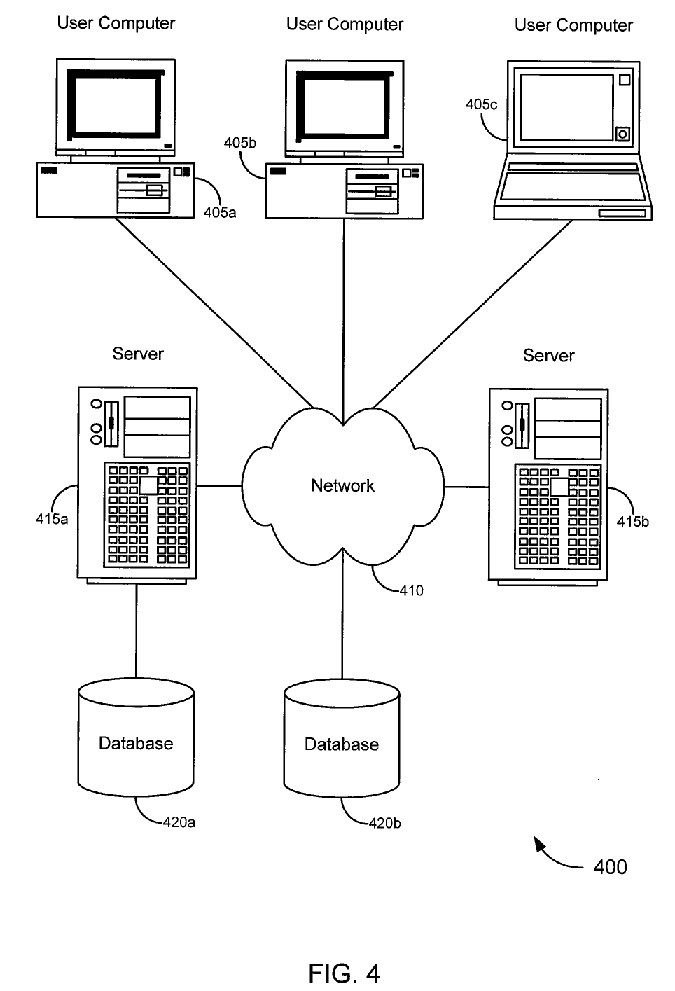

A set of embodiments comprises systems for tracking and displaying financial transactions. Merely by way of example, FIG. 4 illustrates a schematic diagram of a system 400 that can be used in accordance with one set of embodiments. The system 400 can include one or more user computers 405. The user computers 405 can be general purpose personal computers (including, merely by way of example, personal computers and/or laptop computers running any appropriate flavor of Microsoft Corp.'s Windows™ and/or Apple Corp.'s Macintosh™ operating systems) and/or workstation computers running any of a variety of commercially-available UNIX™ or UNIX-like operating systems. These user computers 405 can also have any of a variety of applications, including one or more applications configured to perform methods of the invention, as well as one or more office applications, database client and/or server applications, and web browser applications. Alternatively, the user computers 405 can be any other electronic device, such as a thin-client computer, Internet-enabled mobile telephone, and/or personal digital assistant, capable of communicating via a network (e.g. the network 410 described below) and/or displaying and navigating web pages or other types of electronic documents. Although the exemplary system 400 is shown with three user computers 405, any number of user computers can be supported.

Certain embodiments of the invention operate in a networked environment, which can include a network 410. The network 410 can be any type of network familiar to those skilled in the art that can support data communications using any of a variety of commercially-available protocols, including without limitation TCP/IP, SNA, IPX, AppleTalk™, and the like. Merely by way of example, the network 410 can be a local area network (“LAN”), including without limitation an Ethernet™ network, a Token-Ring™ network and/or the like; a wide-area network; a virtual network, including without limitation a virtual private network (“VPN”); the Internet; an intranet; an extranet; a public switched telephone network (“PSTN”); an infrared network; a wireless network, including without limitation a network operating under any of the IEEE 802.11 suite of protocols, the Bluetooth™ protocol known in the art, and/or any other wireless protocol; and/or any combination of these and/or other networks.

Embodiments of the invention can include one or more server computers 415. Each of the server computers 415 may be configured with an operating system, including without limitation any of those discussed above, as well as any commercially (or freely) available server operating systems. Each of the servers 415 may also be running one or more applications, which can be configured to provide services to one or more clients 405 and/or other servers 415.

Merely by way of example, one of the servers 415 may be a web server, which can be used to process requests for web pages or other electronic documents from user computers 405. The web server can also run a variety of server applications, including HTTP servers, FTP servers, CGI servers, database servers, Java servers, and the like. In some embodiments of the invention, the web server may be configured to serve web pages that can be operated within a web browser on one or more of the user computers 405 to perform methods of the invention.

The server computers 415, in some embodiments, might include one or more file and/or application servers, which can include one or more applications accessible by a client running on one or more of the client computers 405 and/or other servers 415. Merely by way of example, the server(s) 415 can be one or more general purpose computers capable of executing programs or scripts in response to the user computers 405 and/or other servers 415, including without limitation web applications (which might, in some cases, be configured to perform methods of the invention). Merely by way of example, a web application can be implemented as one or more scripts or programs written in any suitable programming language, such as Java™, C, C#™ or C++, and/or any scripting language, such as Perl, Python, or TCL, as well as combinations of any programming/scripting languages. The application server(s) can also include database servers, including without limitation those commercially available from Oracle, Microsoft, Sybase™ , IBM™ and the like, which can process requests from clients (including, depending on the configuration, database clients, API clients, web browsers, etc.) running on a user computer 405 and/or another server 415. In some embodiments, an application server can create web pages dynamically for displaying the information in accordance with embodiments of the invention. Data provided by an application server may be formatted as web pages (comprising HTML, Javascript, etc., for example) and/or may be forwarded to a user computer 405 via a web server (as described above, for example). Similarly, a web server might receive web page requests and/or input data from a user computer 405 and/or forward the web page requests and/or input data to an application server. In some cases a web server may be integrated with an application server.

In accordance with further embodiments, one or more servers 415 can function as a file server and/or can include one or more of the files (e.g., application code, data files, etc.) necessary to implement methods of the invention incorporated by an application running on a user computer 405 and/or another server 415. Alternatively, as those skilled in the art will appreciate, a file server can include all necessary files, allowing such an application to be invoked remotely by a user computer 405 and/or server 415. It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 420. The location of the database(s) 420 is discretionary: merely by way of example, a database 420a might reside on a storage medium local to (and/or resident in) a server 415a (and/or a user computer 405). Alternatively, a database 420b can be remote from any or all of the computers 405, 415, so long as it can be in communication (e.g., via the network 410) with one or more of these. In a particular set of embodiments, a database 420 can reside in a storage-area network (“SAN”) familiar to those skilled in the art. (Likewise, any necessary files for performing the functions attributed to the computers 405, 415 can be stored locally on the respective computer and/or remotely, as appropriate.) In one set of embodiments, the database 435 can be a relational database, such as an Oracle database, that is adapted to store, update, and retrieve data in response to SQL-formatted commands. The database might be controlled and/or maintained by a database server, as described above, for example.

A number of variations and modifications of the invention can also be used within the scope of the invention. For example, various steps of the methods discussed herein can be conducted by multiple processors in different orders than shown in FIG. 1. The invention has now been described in detail for the purposes of clarity and understanding. However, it will be appreciated that certain changes and modifications may be practiced within the scope of the appended claims.

What is claimed is:

1. A method for tracking and reporting multiple financial transactions, the method comprising:
initiating a financial transaction by a user at an interface, wherein the financial transaction includes at least one transactional step; and
generating at least one notification corresponding to the at least one transactional step.

2. The method of claim 1, further comprising:
generating a first notification configured to indicate to the user that payment for the transaction has been initiated;
generating a second notification configured to indicate to the user that the transaction has been processed and released for payment; and
generating a third notification configured to indicate to the user that the transaction's funds have been made available.

3. The method of claim 2, further comprising generating a fourth notification configured to indicate a shipping status of goods associated with the financial transaction.

4. The method of claim 3, further comprising generating a fifth notification configured to indicate that a failure has occurred while processing the transaction.

5. The method of claim 4, wherein the failure includes at least one of insufficient funds, a shipping failure, delayed shipping, delayed payment, and non-compliant goods.

6. The method of claim 4, further comprising generating a report of the status of the transaction based on the first and second notifications.

7. The method of claim 6, wherein the report is further based on the third notification and the fourth notification.

8. The method of claim 6, wherein the report includes a report of each of the transaction steps for each of the multiple transactions.

9. The method of claim 1, further comprising selecting a notification method.

10. The method of claim 9, wherein the selecting of the notification method is performed via at least one of a website, an interactive voice recognition (IVR) system, a voice response unit (VRU) system, a telephone call, an email message, a text message, a facsimile and a paper transaction.

11. The method of claim 9, wherein the notification method is at least one of an email message, a text message, a paper notification, an IVR system, a VRU system, a website, a facsimile and a telephone call.

12. The method of claim 1, wherein the user is at least one of a buyer, a seller, a customer, a shipper, a supplier, and a freight seller.

13. The method of claim 1, further comprising:
accessing a website associated with the financial transaction;
creating an account for the user, wherein the account provides the user with access to the financial transactions; and
accessing the financial transaction via the website.

14. The method of claim 13, wherein the website provides the user with a visual depiction of the plurality of transactional steps.

15. The method of claim 1, wherein the interface includes at least one or more of a web interface, an automated teller machine (ATM) interface, and a mobile device interface.

16. The method of claim 1, wherein the at least one notification is generated in response to executing a notification generation query.

17. The method of claim 16, wherein the notification generation query is initiated by either a sender or a recipient of the financial transaction in order to determine the financial transaction's status.

18. The method of claim 1, further comprising transmitting the at least one notification to the use and a recipient of the financial transaction.

19. A system for tracking and reporting multiple financial transactions, the system comprising:
a payment center configured to receive a financial transaction initiation request, wherein the financial transaction includes at least one transactional step, the payment center further configured to generate at least one notification regarding the at least one transactional step.

20. The system of claim 19, wherein the payment center is further configured to generate a first notification configured to indicate to a user that payment for the financial transaction has been initiated, to generate a second notification configured to indicate to the user that the financial transaction has been processed and released for payment, and to generate a third notification configured to indicate to the user that the financial transaction's funds have been made available.

21. The system of claim 20, wherein the payment center is further configured to generate a fourth notification configured to indicate a shipping status of goods associated with the financial transaction, and to generate a fifth notification configured to indicate that a failure has occurred while processing the financial transaction.

22. A machine-readable medium for tracking and reporting multiple financial transactions which, when executed by a machine, causes the machine to:
initiate a financial transaction by a user at an interface, wherein the financial transaction includes at least one transactional step; and
generate at least one notification corresponding to the at least one transactional step.

23. The machine-readable medium of claim 22, which when further executed by the machine, causes the machine to:
generate a first notification configured to indicate to the user that payment for the transaction has been initiated;
generate a second notification configured to indicate to the user that the transaction has been processed and released for payment; and
generate a third notification configured to indicate to the user that the transaction's funds have been made available.
